(19) United States
(12) Patent Application Publication
(10) Pub. No.: US 2021/0011406 A1
(43) Pub. Date: Jan. 14, 2021

(54) FIXING DEVICE AND IMAGE FORMING APPARATUS

(71) Applicant: BROTHER KOGYO KABUSHIKI KAISHA, Nagoya-shi (JP)

(72) Inventors: Mingguang Zhang, Nagoya-shi (JP); Tokifumi Tanaka, Komaki-shi (JP); Hiroshi Handa, Inazawa-shi (JP); Masahito Kajita, Nagoya-shi (JP)

(73) Assignee: BROTHER KOGYO KABUSHIKI KAISHA, Nagoya-shi (JP)

(21) Appl. No.: 17/034,231

(22) Filed: Sep. 28, 2020

Related U.S. Application Data
(63) Continuation of application No. PCT/JP2019/013143, filed on Mar. 27, 2019.

(30) Foreign Application Priority Data
Mar. 28, 2018 (JP) 2018-063189

(51) Int. Cl. G03G 15/20

(52) U.S. Cl. CPC G03G 15/2053

(57) ABSTRACT

A fixing device comprises a heater, a rotating member, an endless belt, an elastic body and a holder holding the elastic body. The holder includes a base surface supporting the elastic body, a facing portion protruding from the base surface and facing the elastic body in a moving direction in which, in the nip portion, the endless belt moves in a circumferential direction, and a plurality of projecting portions projecting from the facing portion and contacting the elastic body so as to bite into the elastic body in a state in which the elastic body is elastically deformed. The plurality of projecting portions are arranged in a row in a width direction of the endless belt and disposed at positions different from a position of the nip portion in the moving direction.

### CROSS REFERENCE TO RELATED APPLICATIONS

The present application is a continuation application of International Application No. PCT/JP2019/013143, filed on Mar. 27, 2019, which claims priority to Japanese Patent Application No. 2018-063189, filed on Mar. 28, 2018. The contents of these applications are incorporated by in their entirety.

### BACKGROUND

The present disclosure relates to a fixing device fixing a developer image on a sheet, which has been transferred to the sheet.

There is conventionally known a fixing device including a halogen lamp, a heating roll, an endless belt, an elastic body, a nip head member to which the elastic body is attached, and so on. The elastic body presses the endless belt against the heating roll. In this technique, the nip head member is formed in a thin prismatic shape with an L-shape in cross section. The nip head member includes, on an upper surface thereof, a fixing portion for fixing the elastic body and a pressure contact portion provided to protrude in a heating roll direction with respect to the fixing portion.

### SUMMARY

Incidentally, the elastic body is elastically deformed when being pushed onto a rotating member such as the heating roll. However, in the conventional structure, it is possible that the elastic body largely deforms in a longitudinal direction (a width direction) of the endless belt or the elastic body deviates in the width direction.

In view of the above, an object of the present disclosure is to provide a fixing device capable of inhibiting the elastic body from being largely deformed in the width direction of the endless belt and capable of improving positional accuracy of the elastic body.

In order to achieve the above object, a fixing device according to the present disclosure includes a heater, a rotating member heated by the heater, an endless belt, an elastic body, and a holder holding the elastic body. The elastic body forms a nip portion by nipping the endless belt between the elastic body and the rotating member and is elastically deformable.

The holder has a base surface supporting the elastic body, a facing portion, and plural projecting portions. The facing portion protrudes from the base surface. The facing portion faces the elastic body in a moving direction of the endless belt in the nip portion. The plurality of projecting portions projects from the facing portion. The plurality of projecting portions contact the elastic body so as to bite into the elastic body in a state in which the elastic body is elastically deformed.

The projecting portions are arranged in a row in a width direction of the endless belt. The plurality of projecting portions are disposed at positions different from a position of the nip portion in the moving direction.

### BRIEF DESCRIPTION OF THE DRAWINGS

The objects, features, advantages, and technical and industrial significance of the present disclosure will be better understood by reading the following detailed description of the embodiments, when considered in connection with the accompanying drawings, in which:

FIG. 1 is a cross-sectional view of an image forming apparatus including a fixing device according to an embodiment of the disclosure.

FIG. 2 is a cross-sectional view of the fixing device.

FIGS. 3A and B are enlarged cross-sectional views showing an elastic body and a structure therearound arranged upstream in a moving direction of an endless belt in a nip portion, in which FIG. 3A is a view showing a state before a heating unit and a pressure unit are pressed, and FIG. 3B is a view showing a state where these units are pressed.

FIG. 4A is a view showing a holder and the elastic body in a natural state seen from one direction of a pressure direction, and FIG. 4B is a view showing a rotating member, the endless belt, the elastic body, and the holder seen from an upstream side in the moving direction of the endless belt in the nip portion.

FIG. 5 is a view showing the holder and the elastic body in an elastically deformed state due to pressing of the heating unit and the pressure unit seen from one direction of the pressure direction.

FIGS. 6A and 6B are enlarged cross-sectional views showing an elastic body and a structure therearound arranged upstream in the moving direction of an endless belt in a nip portion concerning a fixing device according to a first modification embodiment, in which FIG. 6A is a view showing a state before a heating unit and a pressure unit are pressed, and FIG. 6B is a view showing a state where these units are pressed.

FIG. 7A is a view showing a holder and an elastic body in the natural state seen from one direction of the pressure direction, and FIG. 7B is a view showing the holder and the elastic body in the elastically deformed state concerning a fixing device according to a second modification.

FIG. 8 is a view showing a holder and an elastic body in the elastically deformed state seen from one direction of the pressure direction concerning a fixing device according to a third modification.

FIG. 9A is a view showing a holder and an elastic body in the elastically deformed state seen from one direction of the pressure direction concerning a fixing device according to a fourth modification, and FIG. 9B is a view showing a holder and an elastic body in the elastically deformed state seen from one direction of the pressure direction concerning a fixing device according to a fifth modification.

### EMBODIMENT

Hereinafter, a first embodiment of the disclosure will be explained in detail with reference to the drawings appropriately.

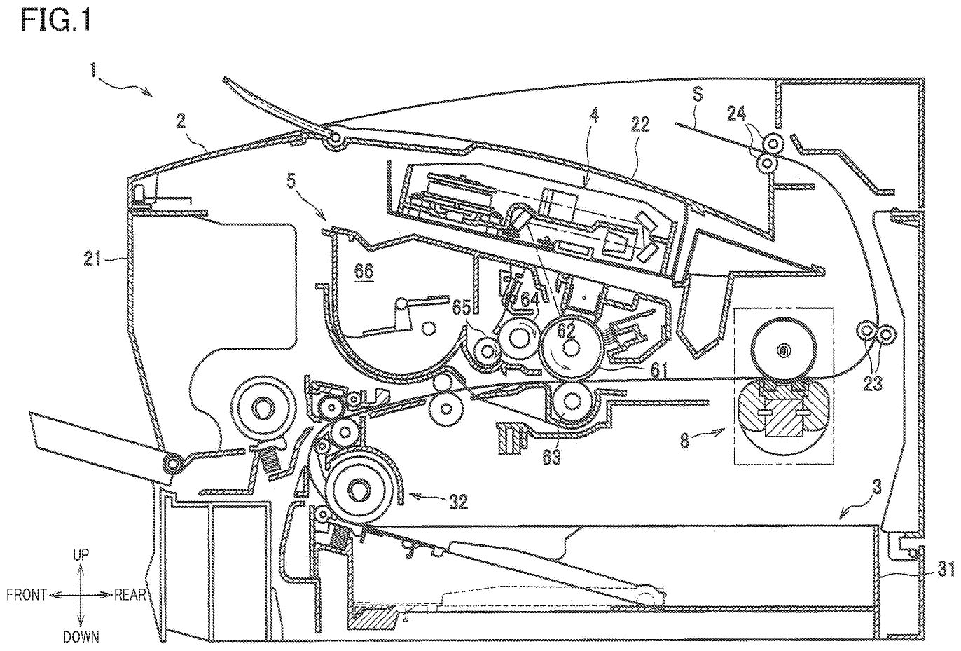

As illustrated in FIG. 1, a fixing device 8 according to the embodiment is used for an image forming apparatus 1 such as a laser printer. The image forming apparatus 1 includes a housing 2, a sheet supplier 3, an exposing device 4, a developer image forming portion 5, and the fixing device 8.

The sheet supplier 3 is provided at a lower portion of the housing 2, including a sheet tray 31 for accommodating sheets S such as paper and a sheet supply mechanism 32. The sheet S in the sheet tray 31 is supplied to the developer image forming portion 5 by the sheet supply mechanism 32.

The exposing device 4 is disposed at an upper portion of the housing 2, including a not-illustrated light source device, a polygon mirror, a lens, a reflective mirror, and so on illustrated without reference numerals. The exposing device 4 exposes a surface of a photoconductor drum 61 by scanning the surface of the photoconductor drum 61 at high speed with a light beam (see a dashed-dotted line) emitted from the light source device based on image data.

The developer image forming portion 5 is disposed below the exposing device 4. The developer image forming portion 5 is configured as a process cartridge so as to be attached to and removed from the housing 2 through an opening formed when opening a front cover 21 provided on the front of the housing 2. The developer image forming portion 5 includes the photoconductor drum 61, a charging unit 62, a transfer roller 63, a developing roller 64, a supply roller 65, and a developer container 66 containing a developer formed of dry toner.

The developer image forming portion 5 uniformly charges the surface of the photoconductor drum 61 by the charging unit 62. After that, the surface of the photoconductor drum 61 is exposed by the light beam emitted from the exposing device 4 to thereby form an electrostatic latent image on the surface of the photoconductor drum 61 based on imaged data. The developer image forming portion 5 also supplies a developer in the developer container 66 to the developing roller 64 through the supply roller 65.

Then, the developer image forming portion 5 supplies the developer on the developing roller 64 to the electrostatic latent image formed on the photoconductor drum 61. This visualizes the electrostatic latent image, and a developer image is formed on the photoconductor drum 61. After that, the developer image forming portion 5 conveys the sheet S supplied from the sheet supplier 3 between the photoconductor drum 61 and the transfer roller 63, so that the developer image on the photoconductor drum 61 is transferred to the sheet S.

The fixing device 8 is disposed behind the developer image forming portion 5. The details of the fixing device 8 will be described later. The fixing device 8 fixes the developer image on the sheet S while the sheet S to which the developer image is transferred is passing through the fixing device 8. The image forming apparatus 1 discharges the sheet S on which the developer image is heat-fixed onto a paper output tray 22 at the outside of the housing 2 by a conveying roller 23 and an output roller 24.

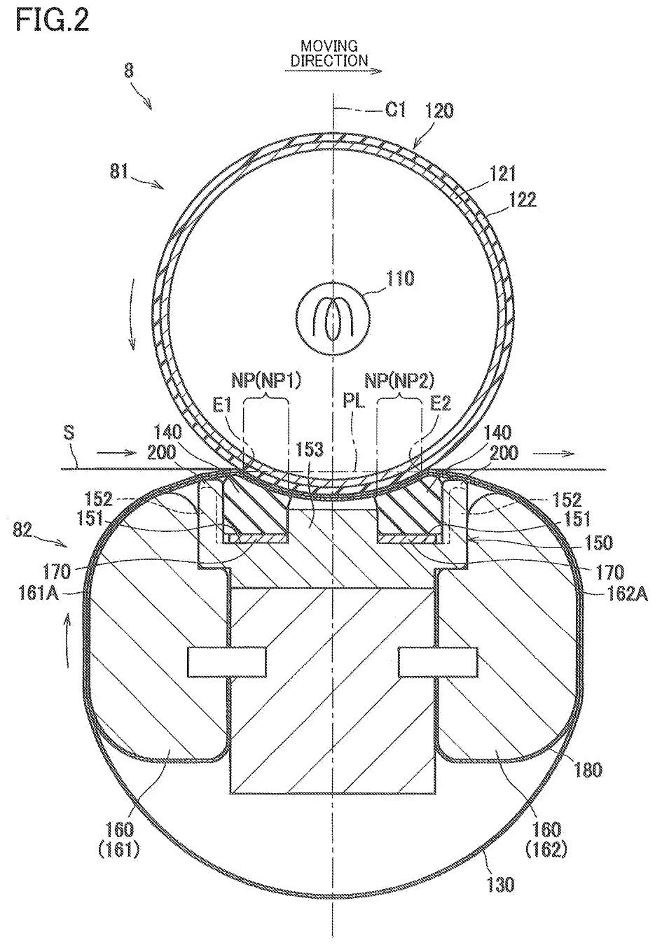

As illustrated in FIG. 2, the fixing device 8 includes a heating unit 81 and a pressure unit 82. One of the heating unit 81 and the pressure unit 82 is pressed to the other by a not-illustrated pressing mechanism.

The heating unit 81 includes a heater 110. The heating unit 81 includes a rotating member 120. The pressure unit 82 includes an endless belt 130. The pressure unit 82 includes an elastic body 140. The pressure unit 82 includes a holder 150. The pressure unit 82 includes a belt guide 160. The pressure unit 82 includes a sliding sheet 180. In the following description, a width direction of the endless belt 130 is referred to as merely a “width direction”. The width direction is a direction parallel to a direction in which a rotation axis line of the rotating member 120 extends.

The heater 110 is a halogen lamp emitting light and generating heat when energized, which heats the rotating member 120 by radiant heat. The heater 110 is disposed so as to extend through the inside of the rotating member 120 along the rotation axis line of the rotating member 120.

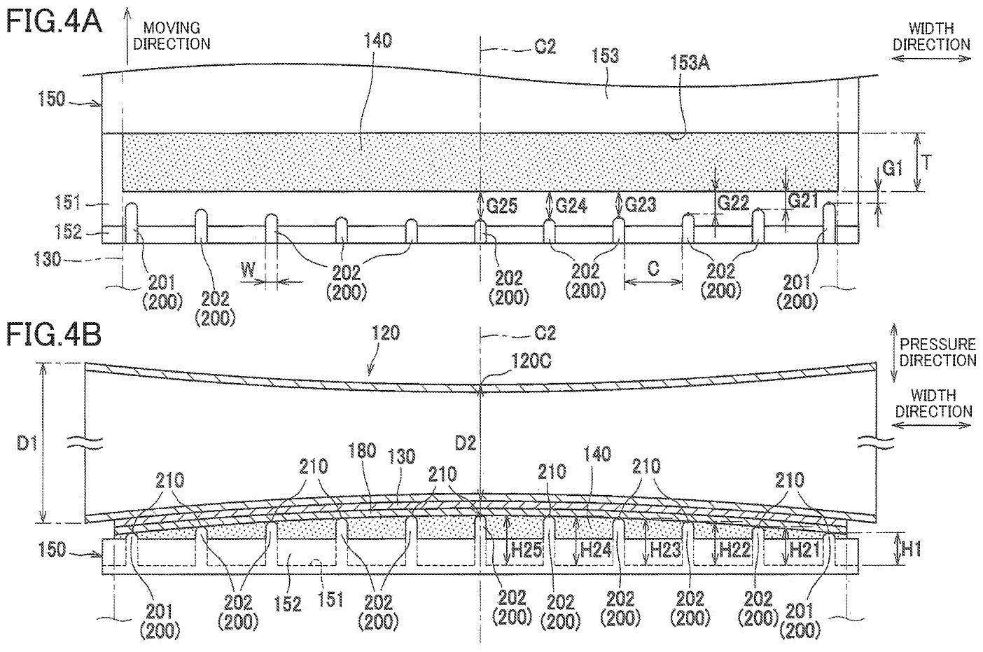

The rotating member 120 is a cylindrical roller elongated in the width direction, which is heated by the heater 110. The rotating member 120 has a blank tube 121 formed of metal or the like and an elastic layer 122 covering an outer circumferential surface of the blank tube 121. In the rotating member 120, an outer diameter at each of ends in the width direction is greater than an outer diameter at a center in the width direction as illustrated in FIG. 4B. Specifically, the rotating member 120 has a concave shape in which an outer diameter D1 at each of the ends of the rotating member 120 in the width direction is greater than an outer diameter D2 at the center of the rotating member 120 in the width direction, and the outer diameter is gradually increased from the center in the width direction toward each of the ends of the rotating member 120.

Returning to FIG. 2, the rotating member 120 is supported by a not-illustrated frame of the fixing device 8 so as to rotate, which is driven to rotate counterclockwise in FIG. 2 when a driving force is inputted from a not-illustrated motor provided in the housing 2 of the image forming apparatus 1.

The endless belt 130 is a long tubular member, having flexibility. The endless belt 130 includes a base material formed of metal, resin, or the like and a release layer covering an outer circumferential surface of the base material, though not illustrated. The endless belt 130 is driven to rotate clockwise in FIG. 2 by friction with respect to the rotating member 120 or the sheet S when the rotating member 120 rotates. Lubricant such as grease is applied to an inner circumferential surface of the endless belt 130.

The elastic body 140 is a member having a rectangular parallelepiped shape elongated in the width direction. Since the elastic body 140 is formed of an elastic material such as rubber having heat resistance, the elastic body 140 can be elastically deformed. The elastic body 140 is disposed inside the endless belt 130. The elastic body 140 forms a nip portion NP by nipping the endless belt 130 between the elastic body 140 and the rotating member 120 disposed outside the endless belt 130 when the heating unit 81 and the pressure unit 82 are pressed.

Here, a moving direction of the endless belt 130 in the nip portion NP is referred to as merely a “moving direction”. The moving direction is a direction parallel to a plane PL passing an upstream end E1 and a downstream end E2 in the nip portion NP in a circumferential direction of the endless belt 130. In the embodiment, the nip portion NP includes an upstream nip portion NP1 and a downstream nip portion NP2 in the circumferential direction of the endless belt 130, therefore, the moving direction is a direction parallel to the plane PL passing the upstream end E1 of the upstream nip portion NP1 and the downstream end E2 of the downstream nip portion NP2. The moving direction is also the same as a conveying direction of the sheet passing the nip portion NP.

The holder 150 is a member for holding the elastic body 140 and is made of resin or the like having heat resistance. The holder 150 is formed to be long in the width direction. The holder 150 includes a base surface 151, a facing portion 152, a restricting portion 153, and projecting portions 200.

The base surface 151 is a surface supporting the elastic body 140, and the base surface 151 is formed to be long in the width direction. The base surface 151 supports a load received by the elastic body 140 from the rotating member 120 through the endless belt 130 when the heating unit 81 and the pressure unit 82 are pressed.

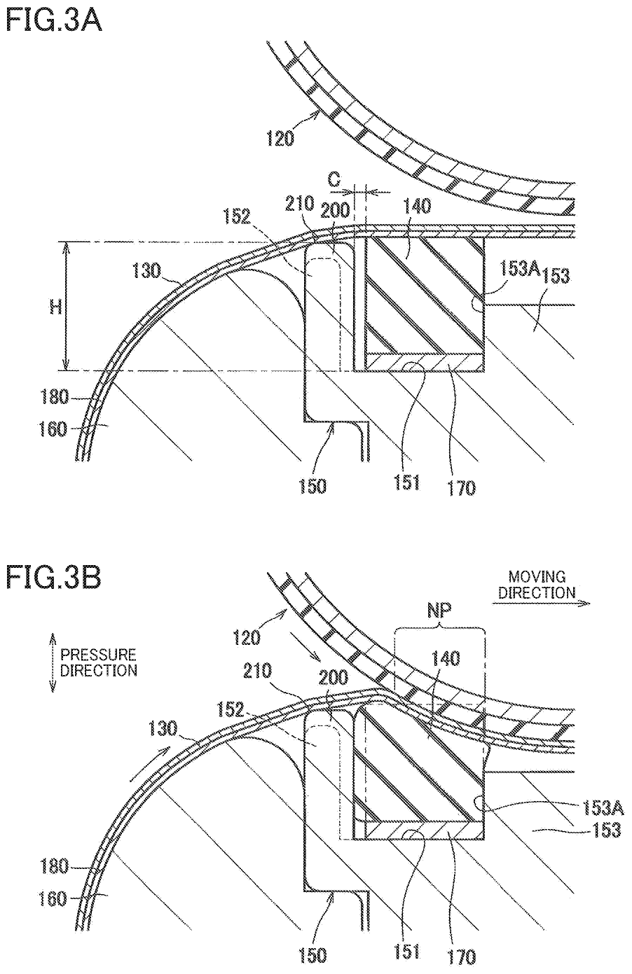

As illustrated in FIGS. 3A and 3B, the base surface 151 supports the elastic body 140 through a fixing member 170. The fixing member 170 is a rectangular plate elongated in the width direction, and the fixing member 170 is formed of metal having higher rigidity than the elastic body 140. The elastic body 140 is firmly adhered to the fixing member 170 by an adhesive or the like. The elastic body 140 is held by the holder 150 through the fixing member 170 by the fixing member 170 being attached to the base surface 151.

The facing portion 152 is formed in a wall shape protruding from the base surface 151 toward the rotating member 120. The facing portion 152 is formed to be long in the width direction along the base surface 151. The facing portion 152 is disposed upstream of the elastic body 140 in the moving direction, and the facing portion faces the elastic body 140 in the moving direction.

The facing portion 152 is disposed at a position different from the position of the nip portion NP in the moving direction. Specifically, the facing portion 152 is disposed upstream of the nip portion NP in the moving direction. In other words, the facing portion 152 is disposed outside an area of the nip portion NP in the moving direction.

The restricting portion 153 is formed so as to protrude from the base surface 151 toward the rotating member 120. The restricting portion 153 is formed to be long in the width direction along the base surface 151 and the facing portion 152. The restricting portion 153 is disposed opposite to the facing portion 152 across the elastic body 140 in the moving direction. The restricting portion 153 is disposed downstream of the elastic body 140 in the moving direction, and the restricting portion 153 faces the facing portion 152 and the elastic body 140 in the moving direction.

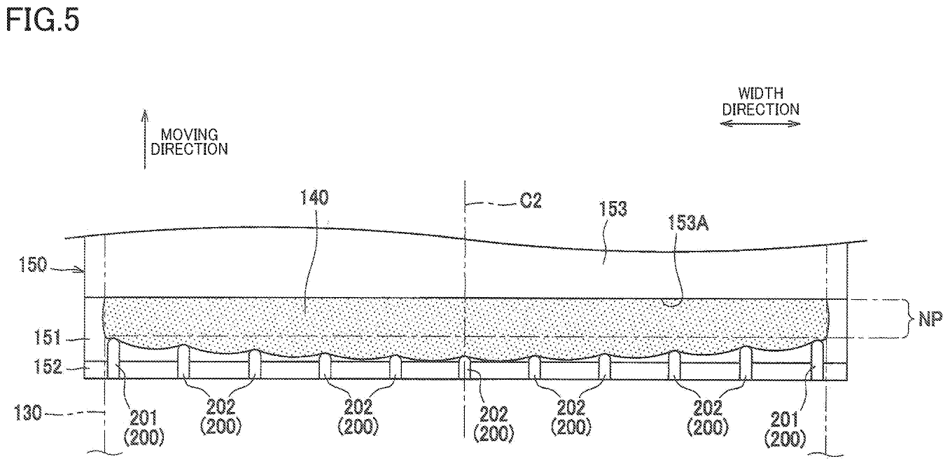

The restricting portion 153 has a restricting surface 153A which is a surface of the restricting portion 153 facing the elastic body 140 in the moving direction. The restricting surface 153A is a surface approximately orthogonal to the moving direction and elongated in the width direction. The restricting surface 153A is in contact with the elastic body 140 from one end to the other end of the elastic body 140 in the width direction in a state in which the elastic body 140 is elastically deformed (see FIG. 5). Accordingly, the restricting portion 153 restricts movement of the elastic body 140 in the moving direction. Specifically, the restricting portion 153 restricts movement of the elastic body 140 to a downstream side in the moving direction.

The projecting portions 200 are portions projecting from the facing portion 152. Specifically, the projecting portions 200 project from the facing portion 152 toward the elastic body 140 and the rotating member 120. The projecting portions 200 are formed mainly from an end face of the facing portion 152 in a pressure direction to a downstream surface in the moving direction of the facing portion 152. As illustrated in FIG. 4B, each of the projecting portions 200 has a plate shape that is thin in the width direction (ribbed shape). A tip end of the projecting portion 200 has an arc shape.

Here, the pressure direction is a direction orthogonal to the moving direction and the width direction. More specifically, the pressure direction is a direction in which the heating unit 81 and the pressure unit 82 are pressed.

The projecting portions 200 include guide surfaces 210. The guide surfaces 210 are end faces of the projecting portions 200 in the pressure direction. The guide surfaces 210 face the rotating member 120 in the pressure direction. Each of the guide surfaces 210 is configured to guide the endless belt 130 toward between the rotating member 120 and the elastic body 140 by contacting an inner circumferential surface of the rotating endless belt 130 through the sliding sheet 180.

The plurality of projecting portions 200 are arranged in a row in the width direction. Specifically, the projecting portions 200 include a pair of end-part projecting portions 201. The projecting portions 200 include a plurality of intermediate projecting portions 202.

The pair of end-part projecting portions 201 are two projecting portions 200 disposed at a corresponding one of endmost positions of the facing portion 152 in the width direction.

The intermediate projecting portions 202 are projecting portions 200 disposed between the pair of end-part projecting portions 201 in the width direction. In the embodiment, nine intermediate projecting portions 202 are provided between the pair of end-part projecting portions 201 in the width direction.

As illustrated in FIG. 4A, a gap G1 is less than each of gaps G21 to G25 in a state in which the elastic body 140 is not elastically deformed. The gap G1 is a gap in the moving direction between the end-part projecting portion 201 and the elastic body 140. Each of the gaps G21 to G25 is a gap in the moving direction between a corresponding one of the intermediate projecting portions 202 and the elastic body 140. The state in which the elastic body 140 is not elastically deformed can be a state in which pressing between the heating unit 81 and the pressure unit 82 are released. That is, a projecting amount of the end-part projecting portion 201 from the facing portion 152 in the moving direction is greater than each of projecting amounts of the intermediate projecting portions 202 from the facing portion 152 in the moving direction in the embodiment.

As illustrated in FIG. 4B, a dimension H1 is less than each of dimensions H21 to H25 in the pressure direction. The dimension H1 is a dimension from the base surface 151 to the guide surface 210 of the end-part projecting portion 201. The dimensions H21 to H25 are respective dimensions from the guide surface 151 to the guide surfaces 210 of the intermediate projecting portions 202. That is, a projecting amount of the end-part projecting portion 201 from the base surface 151 is less than each of projecting amounts of the intermediate projecting portions 202 from the base surface 151 in the pressure direction in the embodiment.

The plurality of projecting portions 200 are provided symmetrically in the width direction with respect to a center C2. The center C2 is positioned in a center of the pair of end-part projecting portions 201 in the width direction. That is, the pair of end-part projecting portions 201 are provided symmetrically in the width direction with respect to the center C2. The plurality of intermediate projecting portions 202 are provided symmetrically in the width direction with respect to the center C2.

Specifically, dimensions in the width direction (widths) W of the projecting portions 200 are identical to one another as illustrated in FIG. 4A. Gaps C between the projecting portions 200 adjacent to each other are also identical to one another.

The gaps between the intermediate projecting portions 202 and the elastic body 140 in the moving direction are gradually reduced in size as going away from the center C2 in order of G25, G24, G23, G22, and G21. In other words, the projecting amount of the projecting portions 200 from the facing portion 152 in the moving direction is increased as going away from the center C2 in the embodiment.

As illustrated in FIG. 4B, the dimensions of the intermediate projecting portions 202 from the base surface 151 to the guide surfaces 210 in the pressure direction are gradually reduced as going away from the center C2 in order of H25, H24, H23, H22, and H21. In other words, the projecting amount of the projecting portions 200 from the base surface 151 in the pressure direction is reduced as going away from the center C2.

Here, it is possible that the widths W of the projecting portions 200 are 0.25T to 60T. A dimension T is a length of the elastic body 140 in the moving direction in a state in which the elastic body 140 is not deformed, namely, in a natural state. The gap C may be 0.1T to 30T. The gap C is the gap between adjacent projecting portions 200 in the width direction. It is possible that the gap G is 0.1T to 0.3T. The gap G is the gap between the projecting portion 200 and the elastic body 140 in the natural state in the moving direction. The dimension H mat be 0.1T to 0.5T. The dimension H is a length from the base surface 151 to the guide surface 210 of the projecting portion 200 in the pressure direction. The dimension H is a height of the projecting portion 200. It is possible that a curvature radius R at the tip end of the projecting portion 200 is 0.1T to 60T. The dimension T may be 3 to 10 mm as an example.

As illustrated in FIG. 3B, respective projecting portions 200 are disposed at positions different from the position of the nip portion NP in the moving direction. Only one of the projecting portions 200 is illustrated in FIG. 3B. Specifically, each of the projecting portions 200 is provided upstream of the elastic body 140 in the moving direction. In other words, each of the projecting portions 200 is provided outside the area of the nip portion NP in the moving direction.

As illustrated in FIG. 5, the projecting portions 200 is in contact with the elastic body 140 so as to bite into the elastic body 140 in the state in which the elastic body 140 is elastically deformed. Specifically, the elastically-deformed elastic body 140 is pushed onto the projecting portions 202 when the heating unit 81 and the pressure unit 82 are pressed, thereby making the projecting portions 200 contact the elastic body 140 so as to bite into the elastic body 140.

In the embodiment, as illustrated in FIG. 2, the base surface 151, the facing portion 152, the restricting surface of the restricting portion 153, and the projecting portions 200 are also provided downstream of a center C1 in the moving direction of the holder 150. The elastic body 140 is also disposed on the base surface 151 positioned downstream of the center C1. The downstream structure is approximately symmetrical to the above upstream structure in the moving direction with respect to the center C1 except that positions are reversed between an upstream side and a downstream side, therefore, explanations thereof are omitted.

The belt guide 160 is a member for guiding the endless belt 130. The belt guide 160 is formed to be long in the width direction. The belt guide 160 includes a first belt guide 161. The belt guide 160 includes a second belt guide 162.

The first belt guide 161 is disposed upstream of the holder 150 in the moving direction. The first belt guide 161 has a first guide surface 161A contacting the inner circumferential surface of the endless belt 130 through the sliding sheet 180. The first belt guide 161 guides the endless belt 130 toward between the rotating member 120 and the elastic body 140.

The second belt guide 162 is disposed downstream of the holder 150 in the moving direction. The second belt guide 162 has a second guide surface 162A contacting the inner circumferential surface of the endless belt 130 through the sliding sheet 180. The second belt guide 162 guides the endless belt 130 coming out of between the rotating member 120 and the elastic body 140 toward the first belt guide 161.

The sliding sheet 180 is a rectangular sheet. The sliding sheet 180 is disposed for reducing sliding resistance between the endless belt 130 and the elastic body 140. The sliding sheet 180 is a sheet made of resin containing polyimide as an example. The sliding sheet 180 is formed such that the dynamic friction force with respect to the endless belt 130 becomes less than the dynamic friction force of the elastic body 140 with respect to the endless belt 130.

Next, operation and effect of the fixing device 8 according to the embodiment will be explained.

As illustrated in FIG. 5, the elastic body 140 contacts the plurality of projecting portions 200 arranged in a row in the width direction so as to bite into the projecting portions 200 when the heating unit 81 and the pressure unit 82 are pressed. Accordingly, it is possible to inhibit the elastic body 140 from being largely deformed so as to spread in the width direction. Since deviation of the elastic body 140 in the width direction can be suppressed, it is possible to improve positional accuracy of the elastic body 140.

The projection portions 200 are disposed at positions different from the position of the nip portion NP in the moving direction. Specifically, the projecting portions 200 are disposed outside the area of the nip portion NP in the moving direction. Therefore, it is possible to reduce effects exerted on the pressure in the nip portion NP due to deformation of the elastic body 140 caused by contact with the projecting portions 200. Accordingly, variation of the pressure in the nip portion NP in the width direction can be suppressed. As a result, it is possible that the developer image transferred to the sheet S by the fixing device 8 is satisfactorily heat-fixed on the sheet S.

The restricting surface 153A of the restricting portion 153 is in contact with the elastic body 140 from one end to the other end in the width direction. Therefore, deformation of the elastic body 140 toward the restricting portion 153 can be suppressed. Accordingly, a deformation amount of the elastic body 140 toward the facing portion 152 can be increased. Therefore, the elastic body 140 is allowed to be bitten by the projecting portions 200 positively. As a result, it is particularly possible to suppress the deviation of the elastic body 140 in the width direction more effectively.

Moreover, the gap G1 is less than each of the gaps G21 to G25 as illustrated in FIG. 4A. Therefore, when the heating unit 81 and the pressure unit 82 are pressed, and the elastic body 140 is pushed onto the rotating member 120 through the endless belt 130 and deformed, each of end parts of the elastic body 140 in the width direction is allowed to be bitten by the end-part projecting portions 201 first. Accordingly, it is particularly possible to inhibit each of the end parts of the elastic body 140 in the width direction from being largely deformed to an outer side in the width direction.

The gaps between the intermediate projecting portions 202 and the elastic body 140 in the natural state are gradually reduced in size as going away from the center C2 in the width direction in order of G25, G24, G23, G22, and G21. Therefore, the elastic body 140 is allowed to be bitten by the projecting portions 200 in order from each of the ends toward the center of the elastic body 140 in the width direction when the elastic body 140 is pushed onto the rotating member 120 through the endless belt 130 and deformed. As a result, it is possible to inhibit the elastic body 140 from being largely deformed to the outer side in the width direction.

Moreover, the projecting potions 200 have the guide surfaces 210 as illustrated in FIG. 4B. Accordingly, it is possible to allow the projecting portions 200 to have a function of guiding the endless belt 130 toward between the rotating member 120 and the elastic body 140.

Since the projecting portions 200 functioning as guides for the endless belt 130 are provided upstream of the elastic body 140 in the moving direction, it is possible to guide the endless belt 130 toward between the rotating member 120 and the elastic body 140 satisfactorily.

Furthermore, the dimension H1 is less than each of the dimensions H21 to H25. Therefore, the projecting portions 200 can be arranged so as to approximately follow the shape of the rotating member 120. Accordingly, the endless belt 130, and further, the sheet S to which the developer image is transferred can be guided toward between the rotating member 120 and the elastic body 140 more satisfactorily by the projecting portions 200 functioning as the guides for the endless belt 130.

In particular, the heights H of the projecting portions 200 are gradually reduced as going away from the center C2 in the width direction in order of H25, H24, H23, H22, and H21 in the intermediate projecting portions 202 according the embodiment. The plurality of projecting portions 200 thus make a crown shape as a whole, therefore, the projecting portions 200 can be arranged along the concave shape of the rotating member 120. Accordingly, the endless belt 130 and the sheet S can be guided toward between the rotating member 120 and the elastic body 140 more satisfactorily by the projecting portions 200 functioning as the guides.

The plurality of projecting portions 200 are provided symmetrically in the width direction with respect to the center C2 of the holder 150 in the width direction. Therefore, the elastic body 140 is allowed to contact the projecting portions 200 in a balanced manner. Accordingly, the deviation of the elastic body 140 in the width direction can be suppressed more satisfactorily. It is also possible to further reduce effects exerted on the pressure in the nip portion NP due to deformation of the elastic body 140 caused by contact with the projecting portions 200.

The embodiment of the disclosure has been explained above, and the present disclosure is not limited to the above embodiment. Specific structures may be appropriately altered within a scope not departing from the gist of the disclosure.

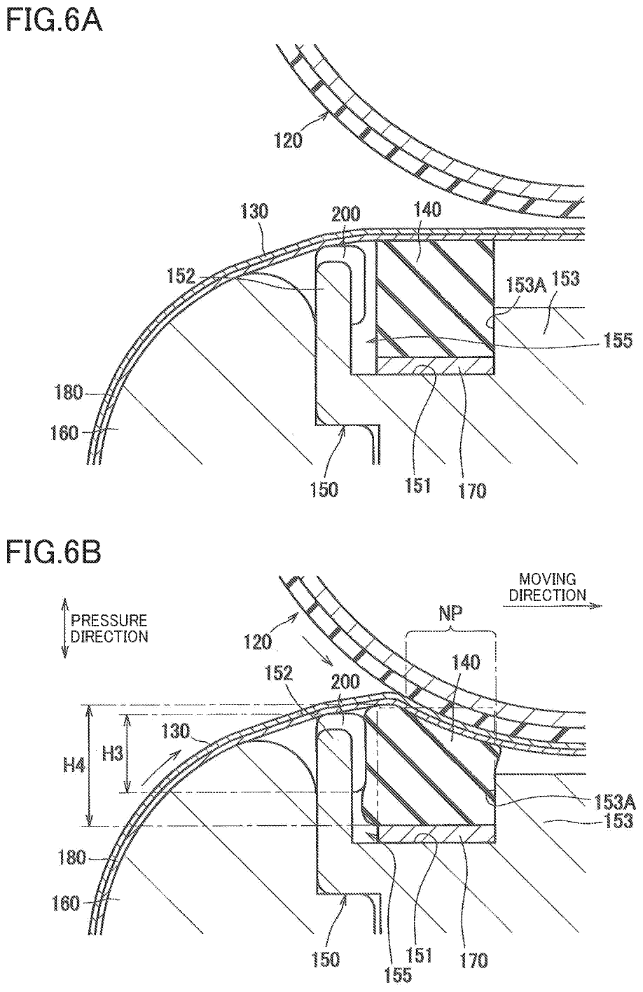

For example, as illustrated in FIG. 6B, a dimension H3 of the projecting portions 200 may be less than a dimension H4 of the elastic body 140 in the pressure direction. The projecting portions 200 may be disposed with a gap from the base surface 151 in the pressure direction as an example.

According to the above structure, a recess 155 can be formed on a surface of the holder 150 facing the elastic body 140. Therefore, as illustrated in FIGS. 6A and 6B, when the rotating member 120 is pressed against the elastic body 140 through the endless belt 130, a part of the deformed elastic body 140 is allowed to escape to the recess 155 that is a portion where the projecting portion 200 is not formed. Accordingly, a contact pressure between the elastic body 140 and the projecting portions 200 can be suppressed. As a result, it is possible to reduce effects exerted on the pressure in the nip portion NP due to deformation of the elastic body 140 caused by contact with the projecting portions 200.

The recess 155 is formed between the projecting portions 200 and the base surface 151 in the pressure direction. Accordingly, a part of the deformed elastic body 140 is allowed to escape to the recess 155, thereby reducing effects exerted on the pressure in the nip portion NP due to the deformation of the elastic body 140. Moreover, end parts of the projecting portions 200 close to the rotating member 120 in the pressure direction are allowed to contact the elastic body 140. Portions of the elastic body 140 close to the rotating member 120 are largely deformed when the elastic body 140 is pushed onto the rotating member 120 through the endless belt 130 as compared with portions firmly adhered to the fixing member 170. When the portions of the elastic body 140 close to the rotating member 120 contact the projecting portions 200, the elastic body 140 is allowed to be bitten by the projecting portions 200 positively. Accordingly, it is possible to inhibit the elastic body 140 from being largely deformed in the width direction. Additionally, positional accuracy of the elastic body 140 can be further improved.

The projecting portions having a less dimension in the pressure direction than the dimension of the elastic body in the pressure direction may be disposed in a state in which the projecting portions connects to the base surface 151 in contrast to the structure illustrated in FIGS. 6A and 6B. That is, the portion for allowing a part of the deformed elastic body to escape may be formed by a surface of the facing portion that faces the elastic body in the moving direction and end faces of the projecting portions that face the rotating member.

The recess for allowing a part of the deformed elastic body to escape may be formed by recessing a part of a face of the projecting portion 200 illustrated in FIG. 3 that faces the elastic body in the moving direction toward a direction away from the elastic body in the moving direction.

Although the dimensions W and the gaps C are identical to one another in the above embodiment, these are not limited to this. Dimensions of the projecting portions in the width direction and gaps between the projecting portions adjacent to each other in the width direction may be different from one another.

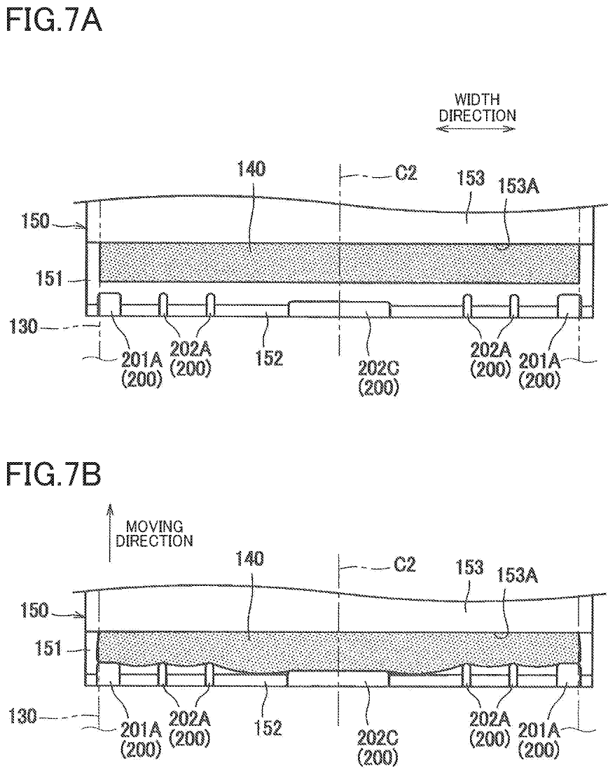

For example, as illustrated in FIGS. 7A and 7B, the projecting portions 200 include a pair of end-part projecting portions 201A and intermediate projecting portions 202A, 202C. The intermediate projecting portion 202C is disposed at a position overlaying the center C2 between the pair of end-part projecting portions 201A in the width direction. Two intermediate projecting portions 202A are disposed between each of the pair of end-part projecting portions 201A and the intermediate projecting portion 202C. Then, a dimension of each of the pair of the end-part projecting portions 201A in the width direction is greater than a dimension of each of the intermediate projecting portions 202A in the width direction. A dimension of the intermediate projecting portion 202C in the width direction is greater than the dimension of each of the pair of end-part projecting portions 201A in the width direction. Moreover, a gap between the intermediate projecting portion 202A and the intermediate projecting portion 202C is greater than a gap between one of the pair of end-part projecting portions 201A and the intermediate projecting portion 202A and a gap between the two adjacent intermediate projecting portions 202A in the width direction.

In the embodiment illustrated in FIGS. 7A and 7B, the number of the intermediate projecting portions 202A, 202C are different from the number of the intermediate projecting portions 202 in the above embodiment, however, the number of the intermediate projecting portions is not particularly limited. For example, the number of the intermediate projecting portions may be greater than that of the above embodiment, or one intermediate projecting portion may be provided.

Furthermore, the projecting portions 200 are respectively provided upstream and downstream of the elastic body 140 in the moving direction in the above embodiment, however, the projecting portions are not limited to this. For example, the projecting portions may be provided only upstream of the elastic body in the moving direction. The projecting portions may also be provided only downstream of the elastic body in the moving direction.

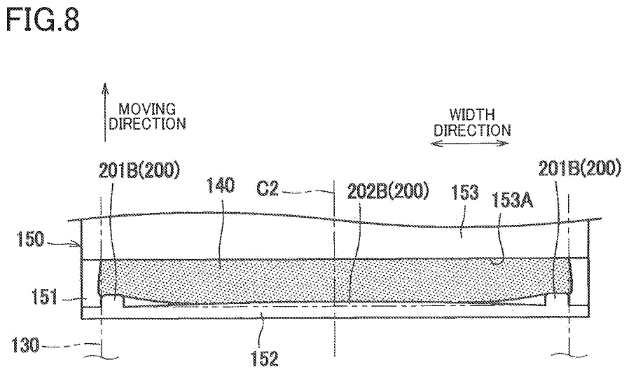

The number of the projecting portions provided upstream of the elastic body in the moving direction is two or more. The same applies to the number of the projecting portions provided downstream of the elastic body in the moving direction. For example, as illustrated in FIG. 8, the number of the projecting portions 200 provided upstream of the elastic body 140 in the moving direction may be three.

In the example illustrated in FIG. 8, the projecting portions 200 include a pair of end-part projecting portions 201B and one intermediate projecting portion 202B. The intermediate projecting portion 202B is disposed between the pair of end-part projecting portions 201B. The intermediate projecting portion 202B is formed to be long from one end-part projecting portion 201B to the other end-part projecting portion 201B in the width direction. Then, the intermediate projecting portion 202B has a shape in which a projecting amount toward the elastic body 140 in the moving direction is increased as coming close to a center from ends of the facing portion 152 in the width direction.

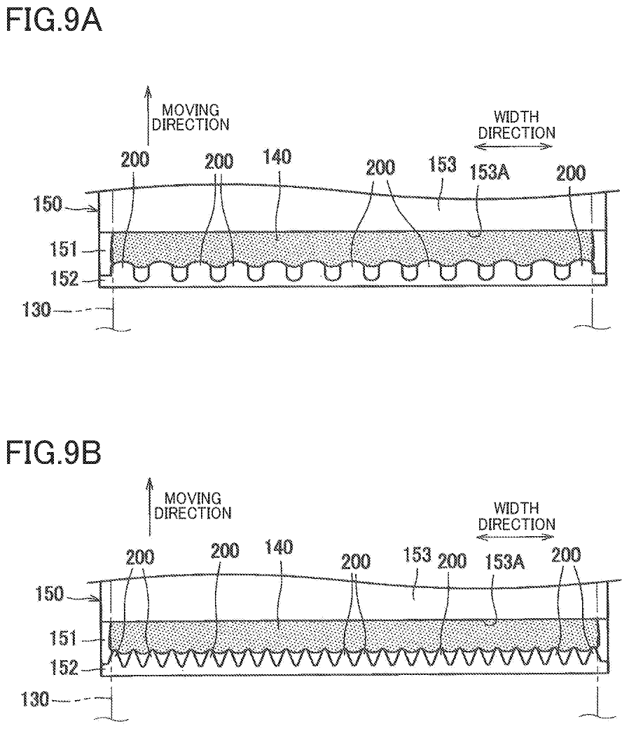

Although the projecting portions 200 are formed in the ribbed shape in the above embodiment, the shape of the projecting portions is not particularly limited. For example, as illustrated in FIG. 9A, each of the projecting portions 200 may be formed to be longer in the width direction than the projecting portions 200 illustrated in the above embodiment. As illustrated in FIG. 9A, each of the projecting portions 200 may have arc-shaped tip ends, and the plurality of projecting portions 200 may form a wave shape as a whole. Moreover, as illustrated in FIG. 9B, each of the projecting portions 200 may be formed in an approximately triangular shape, and plural projecting portions 200 may form a serrated shape as a whole.

In the above embodiment, the gap between each of the pair of end-part projecting portions 201 and the elastic body 140 in the natural state are less than the gaps between the intermediate projecting portions 202 and the elastic body 140 in the natural state in the moving direction, however, the gaps may be identical. The gaps between the plurality of intermediate projecting portions and the elastic body in the natural state in the moving direction may be identical to one another, or may be identical to the gap of each of the pair of end-part projecting portions. For example, as illustrated in FIG. 7A, gaps between the intermediate projecting portions 202A and the elastic body 140 in the natural state in the moving direction may be identical to the gap between each of the pair of end-part projecting portions 201A and the elastic body 140 in the natural state.

The dimensions from the base surface 151 to the guide surfaces 210 of the pair of end-part projecting portions 201 in the pressure direction are less than the dimensions from the base surface 151 to the guide surfaces 210 of the intermediate projecting portions 202 in the above embodiment, however, the dimensions may be identical. The dimensions from the base surface to the guide surfaces of the plurality of intermediate projecting portions may be identical to one another, or may be identical to dimensions in the pair of end-part projecting portions. The projecting amounts of the projecting portions from the base surface in the pressure direction are preferably determined such that the plurality of projecting portions arranged in a row in the width direction form a shape approximately following the shape of the rotating member as a whole.

The plurality of projecting portions 200 are provided symmetrically in the width direction with respect to the center of the holder 150 in the width direction in the above embodiment, however, the projecting portions 200 are not limited to this, and the plurality of projecting portions may be provided so as not to be symmetrical.

Although the projecting portions 200 have the guide surfaces 210 for guiding the endless belt 130 in the above embodiment, the projecting portions are not limited to this. The projecting portions may be portions not having the function of guiding the endless belt.

The holder 150 is a member separate from the belt guide 160 in the above embodiment, however, the structure is not limited to this. That is, the holder according to the disclosure may be a member in which the holder 150 and the belt guide 160 according to the embodiment are integrally formed. Moreover, the surface of the facing portion 152 facing the elastic body 140 in the moving direction and the restricting surface 153A of the restricting portion 153 are planes parallel to the width direction. However, the surfaces are not limited to this and may be, for example, curved surfaces.

Although the elastic body 140 has the rectangular parallelepiped shape, the elastic body 140 is not limited to this. The elastic body may have any shape.

The rotating member 120 has the concave shape in the above embodiment, however, the shape of the rotating member is not particularly limited. Moreover, the rotating member 120 is a cylindrical roller in the above embodiment, however, the rotating member 120 is not limited to this. For example, the rotating member may be an endless belt or the like. That is, the fixing device according to the disclosure may have a structure including the endless belt and a second endless belt as the rotating member.

Moreover, the halogen lamp utilizing radiant heat is cited as an example of the heater 110 in the above embodiment, however, the heater is not limited to this. For example, a ceramic heater or a carbon heater utilizing heat generation of a resistor may be adopted. The heater may also be an IH heater or the like inductively heating the rotating member. The heater may also be arranged outside the rotating member, not inside the rotating member.

In the above embodiment, the heating unit 81 includes the heater 110 and the rotating member 120, and the pressure unit 82 includes the endless belt 130, the elastic body 140, and the holder 150, however, the structure is not limited to this. For example, the fixing device may have a structure in which the heating unit has the heater, the endless belt, the elastic body, and the holder, and the pressure unit includes the rotating member. The rotating member in the pressure unit is not limited to an endless belt. For example, a roller including a core metal and an elastic layer covering an outer circumferential surface of the core metal or the like may be used. When the heating unit includes the endless belt, the heater may be disposed inside the endless belt or may be disposed outside the endless belt.

The example in which the fixing device according to the disclosure is applied to the image forming apparatus for forming a monochrome image on the sheet has been explained in the above embodiments, however, the fixing device is not limited to this. For example, the fixing device may be applied to an image forming apparatus capable of forming a colored image on the sheet. The image forming apparatus is not limited to the laser printer. For example, a printer exposing the photoconductor drum by light emitted from an LED may be applicable. The image forming apparatus may be a copying machine or a multifunction machine including a manuscript reader such as a flatbed scanner.

Respective elements explained in the above embodiments and modification examples may be suitably combined to achieve the examples.

What is claimed is:

1. A fixing device comprising:
a heater;
a rotating member heated by the heater;
an endless belt;
an elastic body forming a nip portion by nipping the endless belt between the elastic body and the rotating member, the elastic body being elastically deformable; and
a holder holding the elastic body,
wherein the holder includes:
a base surface supporting the elastic body;
a facing portion protruding from the base surface and facing the elastic body in a moving direction in which, in the nip portion, the endless belt moves in a circumferential direction; and
a plurality of projecting portions projecting from the facing portion and contacting the elastic body so as to bite into the elastic body in a state in which the elastic body is elastically deformed, and
wherein the plurality of projecting portions are arranged in a row in a width direction of the endless belt and disposed at positions different from a position of the nip portion in the moving direction.

2. The fixing device according to claim 1,
wherein the holder includes a restricting portion restricting movement of the elastic body in the moving direction and interposing the elastic body with the facing portion in the moving direction, and
wherein the restricting portion is in contact with the elastic body from one end to the other end in the width direction in the state in which the elastic body is elastically deformed.

3. The fixing device according to claim 1,
wherein a dimension of at least one of the plurality of projecting portions in a pressure direction orthogonal to the moving direction and the width direction is less than a dimension of the elastic body in the pressure direction.

4. The fixing device according to claim 3,
wherein the at least one of the plurality of projecting portions is disposed with a gap from the base surface in the pressure direction.

5. The fixing device according to claim 1,
wherein the plurality of projecting portions include a pair of end-part projecting portions each disposed a corresponding one of at endmost positions in the width direction and an intermediate projecting portion disposed between the pair of end-part projecting portions in the width direction, and
wherein, in a state in which the elastic body is not elastically deformed, a gap between one of the pair of end-part projecting portions and the elastic body in the moving direction is less than a gap between the intermediate projecting portion and the elastic body in the moving direction.

6. The fixing device according to claim 5,
wherein the intermediate projecting portion is a first intermediate projecting portion positioned at a center position between the pair of end-part projecting portions in the width direction,
wherein the plurality of projecting portions include a plurality of second intermediate projecting portions each positioned between the first intermediate projecting portion and one of the pair of end-part projecting portions in the width direction, and
wherein, in the state in which the elastic body is not elastically deformed, a gap between the first intermediate projecting portion and the elastic body in the moving direction is greater than a gap between at least one of the plurality of second intermediate projecting portions and the elastic body in the moving direction.

7. The fixing device according to claim 6,
Wherein, in the state in which the elastic body is not elastically deformed, gaps between the plurality of second intermediate projecting portions and the elastic body in the moving direction are reduced in size as going away from the first intermediate projecting portion.

8. The fixing device according to claim 1,
wherein at least one of the plurality of projecting portions has a guide surface configured to guide the endless belt toward between the rotating member and the elastic body by contacting an inner circumferential surface of the endless belt.

9. The fixing device according to claim 8,
wherein the rotating member is a roller in which an outer diameter at each of ends in the width direction are greater than an outer diameter at a center in the width direction,
wherein the plurality of projecting portions include a pair of end-part projecting portions each disposed at a corresponding one of endmost positions in the width direction and an intermediate projecting portion disposed between the pair of end-part projecting portions in the width direction, and
wherein a dimension, in a pressure direction orthogonal to the moving direction and the width direction, from the base surface to the guide surface of the pair of end-part projecting portions is less than a dimension in the pressure direction from the base surface to the guide surfaces of the intermediate projecting portion.

10. The fixing device according to claim 9,
wherein the intermediate projecting portion is a first intermediate projecting portion positioned at a center position between the pair of end-part projecting portions in the width direction,
wherein the plurality of projecting portions include a plurality of second intermediate projecting portions each positioned between the first intermediate projecting portion and one of the pair of end-part projecting portions in the width direction, and
wherein a dimension in the pressure direction from the base surface to the guide surface of the first intermediate projecting portion is greater than a dimension in the pressure direction from the base surface to the guide surface of at least one of the second intermediate projecting portions.

11. The fixing device according to claim 10,
wherein dimensions of the plurality of second intermediate projecting portions in the pressure direction from the base surface to the guide surfaces are reduced as going away from the first intermediate projecting portion.
